(19) United States
(12) Patent Application Publication
(10) Pub. No.: US 2008/0045668 A1
(43) Pub. Date: Feb. 21, 2008

(54) FREE-FLOWING POLYOXYMETHYLENES

(75) Inventors: Peter Eibeck, Ludwigshafen (DE); Bernd Bruchmann, Freinsheim (DE); Andreas Eipper, Ludwigshafen (DE); Jean-Francois Stumbe, Strasbourg (FR); Melanie Urtel, Edingen-Neckarhausen (DE); Wolfgang Sauerer, Birkenheide (DE)

Correspondence Address: CONNOLLY BOVE LODGE & HUTZ LLP, 1875 EYE STREET, N.W., SUITE 1100, WASHINGTON, DC, 20036, US

(73) Assignee: BASF AKTIENGESELLSCHAFT, Ludwigshafen (DE)

(21) Appl. No.: 11/577,587

(22) PCT Filed: Oct. 12, 2005
(86) PCT No.: PCT/EP05/10954

§ 371 Date: Apr. 19, 2007

(30) Foreign Application Priority Data
Oct. 20, 2004 (DE) 10 2004 051 214.0

(51) Int. Cl. C08L 61/02

(52) U.S. Cl. 525/398

(57) ABSTRACT

Thermoplastic molding compositions, comprising A) from 10 to 98% by weight of at least one polyoxymethylene homo- or copolymer, B) from 0.01 to 50% by weight of B1) at least one highly branched or hyperbranched polycarbonate with an OH number of from 1 to 600 mg KOH/g of polycarbonate (to DIN 53240, Part 2), or
B2) at least one highly branched or hyperbranched polyester of AₓB_{y} type, where x is at least 1.1 and y is at least 2.1, or a mixture of these, C) from 0 to 60% by weight of other additives, where the total of the percentages by weight of components A) to C) is 100%.

The invention relates to thermoplastic molding compositions, comprising
A) from 10 to 98% by weight of at least one polyoxymethylene homo- or copolymer,
B) from 0.01 to 50% by weight of
B1) at least one highly branched or hyperbranched polycarbonate with an OH number of from 1 to 600 mg KOH/g of polycarbonate (to DIN 53240, Part 2), or
B2) at least one highly branched or hyperbranched polyester of AₓB_{y} type, where x is at least 1.1 and y is at least 2.1, or a mixture of these,
C) from 0 to 60% by weight of other additives,
   where the total of the percentages by weight of components A) to C) is 100%.

The invention further relates to the use of the inventive molding compositions for production of fibers, foils, or moldings of any type, and also to the resultant moldings.

Polycarbonates are usually obtained from the reaction of alcohols with phosgene or from transesterification of alcohols or phenols, using dialkyl or diaryl carbonates. Industrially significant materials are aromatic polycarbonates produced, for example, from bisphenols, while aliphatic polycarbonates are of less importance in market volume terms. See also in this connection Becker/Braun, Kunststoff-Handbuch [Plastics Hand-book] vol. 3/1, Polycarbonate, Polyacetale, Polyester, Celluloseester [Polycarbonates, Polyacetals, Polyesters, Cellulose Esters], Carl-Hanser-Verlag, Munich 1992, pages 118-119.

The aliphatic polycarbonates described are generally linear or else have a structure with a very small degree of branching. For example, U.S. Pat. No. 3,305,605 describes the use of solid linear polycarbonates with a molecular weight above 15 000 dalton as plasticizer for polyvinyl polymers.

Low-molecular-weight additives are usually added to thermoplastics to improve flowability. However, these additives have very limited effectiveness because, for example, when the added amount of the additive increases the fall-off in mechanical properties becomes unacceptable.

High-functionality polycarbonates of defined structure have been known only for a short time.

S. P. Rannard and N. J. Davis, J. Am. Chem. Soc. 2000,122, 11729 describe the preparation of perfectly branched dendrimeric polycarbonates via reaction of carbonyl-bisimidazole as phosgene-analogous compound with bishydroxyethylamino-2-propanol. Syntheses to give perfect dendrimers have four stages and are therefore expensive and not very suitable for industrial scale-up.

D. H. Bolton and K. L. Wooley, Macromolecules 1997, 30, 1890 describe the preparation of high-molecular-weight, highly rigid hyperbranched aromatic polycarbonates via reaction of 1,1,1-tris(4′-hydroxyphenyl)ethane with carbonylbisimidazole.

Hyperbranched polycarbonates can also be prepared as in WO 98/50453. In the process described there, triols are again reacted with carbonylbisimidazole. The first product is imidazolides, and these are then further reacted intermolecularly to give the polycarbonates. The method mentioned gives the polycarbonates in the form of colorless or pale yellow rubbery products.

The syntheses mentioned to give highly branched or hyperbranched polycarbonates have the following disadvantages:
a) The hyperbranched products either have a high melting point or are rubbery, the result being significant limitation on subsequent processability.
b) Imidazole liberated during the reaction has to be removed from the reaction mixture in a complicated process.
c) The reaction products always comprise terminal imidazolide groups. These groups are labile and have to be converted into, for example, hydroxy groups by way of a subsequent step.
d) Carbonyldiimidazole is a comparatively expensive chemical which greatly increases raw material costs.

WO-97/45474 discloses thermoplastic compositions which comprise dendrimeric polyesters in the form of an AB₂ molecule in a polyester. Here, a polyhydric alcohol as core molecule reacts with dimethylpropionic acid as AB₂ molecule to give a dendrimeric polyester. This comprises only OH functionalities at the end of the chain. Disadvantages of these mixtures are the high glass transition temperature of the dendrimeric polyesters, the comparatively complicated preparation process, and especially the poor solubility of the dendrimers in the polymer matrix.

According to the teaching of DE-A 101 32 928, the incorporation of branching agents of this type by means of compounding and solid-phase post-condensation improves mechanical properties (molecular weight increase). Disadvantages of the process variant described are the long preparation time and the disadvantageous properties previously mentioned.

DE 102004 005652.8 and DE 102004 005657.9 have previously proposed novel flow-improver additives for polyesters.

Known flow improvers for POM are: silicone oils, amines, phthalates, epoxy compounds, fatty acid esters, sulfonates, etc., e.g. disclosed in BE-A 720 658, CA-A 733 567, DE-A 222 868, EP-A 47 529, SU 519 449, JP-A 06/100 758, DE-A 31 511 814.

It was therefore an object of the present invention to provide thermoplastic polyoxymethylene molding compositions which have good flowability together with good mechanical properties.

Accordingly, the molding compositions defined at the outset have been found. Preferred embodiments are given in the subclaims.

The inventive molding compositions comprise, as component A), from 10 to 98% by weight, preferably from 30 to 98% by weight, and in particular from 40 to 98% by weight, of a polyoxymethylene homo- or copolymer.

These polymers are known per se to the person skilled in the art and are described in the literature.

These polymers very generally have at least 50 mol% of —CH₂O— repeat units in the main polymer chain.

The homopolymers are generally prepared by polymerizing formaldehyde or trioxane, preferably in the presence of suitable catalysts.

For the purposes of the invention, component A is preferably polyoxymethylene co-polymers, especially those which, besides the —CH₂O— repeat units, also have up to 50 mol %, preferably from 0.1 to 20 mol %, in particular from 0.3 to 10 mol %, and very particularly preferably from 0.2 to 2.5 mol %, of 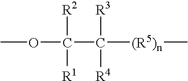
repeat units, where R¹ to R⁴, independently of one another, are a hydrogen atom, a C₁-C₄-alkyl group or a halogen-substituted alkyl group having from 1 to 4 carbon atoms, and R⁵ is a —CH₂—, —CH₂O—, C₁-C₄-alkyl- or C₁-C₄-haloalkyl-substituted methylene group or a corresponding oxymethylene group, and n is in the range from 0 to 3. These groups may be advantageously introduced into the copolymers by ring-opening of cyclic ethers. Preferred cyclic ethers have the formula 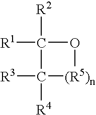
where R¹ to R⁵ and n are as defined above. Mention may be made, merely as examples, of ethylene oxide, propylene 1,2-oxide, butylene 1,2-oxide, butylene 1,3-oxide, 1,3-dioxane, 1,3-dioxolane and 1,3-dioxepan as cyclic ethers, and also linear oligo- and polyformals, such as polydioxolane or polydioxepan as comonomers.

Other suitable components A) are oxymethylene terpolymers, prepared, for example, by reacting trioxane, one of the cyclic ethers described above and a third monomer, preferably bifunctional compounds of the formula 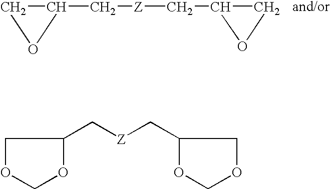
where Z is a chemical bond, —O—, —ORO—(R═C₁-C₈-alkylene or C₃-C₈-cycloalkylene).

Preferred monomers of this type are ethylene diglycide, diglycidyl ether and diethers made from glycidyl compounds and formaldehyde, dioxane or trioxane in a molar ratio of 2:1, and also diethers made from 2 mol of glycidyl compound and 1 mol of an aliphatic diol having from 2 to 8 carbon atoms, for example the diglycidyl ether of ethylene glycol, 1,4-butanediol, 1,3-butanediol, 1,3-cyclobutanediol, 1,2-propanediol or 1,4-cyclohexanediol, to mention merely a few examples.

Processes for preparing the homo- and copolymers described above are known to the person skilled in the art and described in the literature, and further details are therefore superfluous here.

The preferred polyoxymethylene copolymers have melting points of at least 160° C. to 170° C. (DSC, ISO 3146) and molecular weights (weight-average) M_{w} in the range from 5000 to 300 000, preferably from 7000 to 250 000 (GPC, PMMA standard).

Particular preference is given to end-group-stabilized polyoxymethylene polymers which have C—C bonds at the ends of the chains.

The inventive molding compositions comprise, as component B), from 0.01 to 50% by weight, preferably from 0.5 to 20% by weight, and in particular from 0.7 to 10% by weight, of B1) at least one highly branched or hyperbranched polycarbonate with an OH number of from 1 to 600, preferably from 10 to 550, and in particular from 50 to 550, mg KOH/g of polycarbonate (to DIN 53240, Part 2), or at least one hyperbranched polyester as component B2), or a mixture of these, as explained below.

For the purposes of this invention, hyperbranched polycarbonates B1) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B1) preferably has a number-average molar mass Mₙ of from 100 to 15 000 g/mol, preferably from 200 to 12 000 g/mol, and in particular from 500 to 10 000 g/mol (GPC, PMMA standard).

The glass transition temperature T_{g} is in particular from −80° C. to 140° C., preferably from −60° C. to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component B1) is preferably obtainable via a process which comprises at least the following steps:
a) reaction of at least one organic carbonate (A) of the general formula RO[(CO)]ₙOR with at least one aliphatic, aliphatic/aromatic, or aromatic alcohol (B) which has at least 3 OH groups, with elimination of alcohols ROH to give one or more condensates (K), where each R, independently of the others, is a straight-chain or branched aliphatic, aromaticlaliphatic, or aromatic hydrocarbon radical having from 1 to 20 carbon atoms, and where the radicals R may also have bonding to one another to form a ring, and n is a whole number from 1 to 5, or
ab) reaction of phosgene, diphosgene, or triphosgene with abovementioned alcohol (B) with elimination of hydrogen chloride,
b) intermolecular reaction of the condensates (K) to give a high-functionality, highly branched, or high-functionality, hyperbranched polycarbonate,
   where the quantitative proportion of the OH groups to the carbonates in the reaction mixture is selected in such a way that the condensates (K) have an average of either one carbonate group and more than one OH group or one OH group and more than one carbonate group.

Starting materials which may be used comprise phosgene, diphosgene, or triphosgene, preference being given to organic carbonates.

Each of the radicals R of the organic carbonates (A) used as starting material and having the general formula RO(CO)OR is, independently of the others, a straight-chain or branched aliphatic, aromatic/aliphatic, or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms, or a substituted or unsubstituted phenyl radical.

Use is particularly made of simple carbonates of the formula RO(CO)OR; n is preferably from 1 to 3, in particular 1.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic, aromatic/aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates in which n is greater than 1 comprise dialkyl dicarbonates, such as di(tert-butyl) dicarbonate, or dialkyl tricarbonates, such as di(tert-butyl)tricarbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (B) which has at least 3 OH groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, bis(trimethylolpropane), or sugars, e.g. glucose, trihydric or higher-functionality polyetherols based on trihydric or higher-functionality alcohols and ethylene oxide, propylene oxide, or butylene oxide, or polyesterols. Particular preference is given here to glycerol, trimethylolethane, trimethylolpropane, 1,2,4-butanetriol, pentaerythritol, and their polyetherols based on ethylene oxide or propylene oxide.

These polyhydric alcohols may also be used in a mixture with dihydric alcohols (B′), with the proviso that the average OH functionality of the totality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxyphenyl)sulfide, bis(4-hydroxyphenyl)sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, dihydric polyether polyols based on ethylene oxide, propylene oxide, butylene oxide, or their mixtures, polytetrahydrofuran, polycaprolactone, or polyesterols based on diols and dicarboxylic acids.

The diols serve for fine adjustment of the properties of the polycarbonate. If use is made of dihydric alcohols, the ratio of dihydric alcohols B′) to the at least trihydric alcohols (B) is set by the person skilled in the art as a function of the desired properties of the polycarbonate. The amount of the alcohol(s) (B′) is generally from 0 to 39.9 mol %, based on the entire amount of the totality of all of the alcohols (B) and (B′). The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the inventive high-functionality highly branched polycarbonate takes place with elimination of the monohydric alcohol or phenol from the carbonate molecule.

After the reaction, i.e. without further modification, the high-functionality highly branched polycarbonates formed by the inventive process have termination by hydroxy groups and/or by carbonate groups. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a high-functionality polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The high-functionality polycarbonates of the present invention mostly have not more than 500 terminal or pendant functional groups, preferably not more than 100 terminal or pendant functional groups.

When preparing the high-functionality polycarbonates B1), it is necessary to adjust the ratio of the compounds comprising OH groups to phosgene or carbonate in such a way that the simplest resultant condensate (hereinafter termed condensate (K)) comprises an average of either one carbonate group or carbamoyl group and more than one OH group or one OH group and more than one carbonate group or carbamoyl group. The simplest structure of the condensate (K) composed of a carbonate (A) and a di- or polyalcohol (B) here results in the arrangement XYₙ or YₙX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (K) from a carbonate and a dihydric alcohol the reaction ratio is 1:1, the average result is a molecule of XY type, illustrated by the general formula 1.

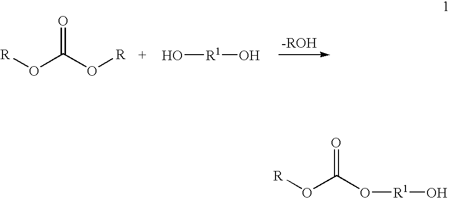

During the preparation of the condensate (K) from a carbonate and a trihydric alcohol with a reaction ratio of 1:1, the average result is a molecule of XY₂ type, illustrated by the general formula 2. A carbonate group is focal group here.

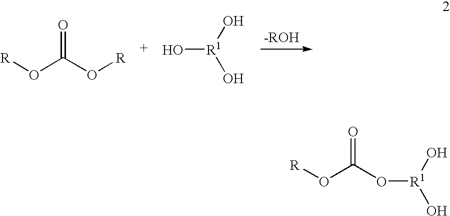

During the preparation of the condensate (K) from a carbonate and a tetrahydric alcohol, likewise with the reaction ratio 1:1, the average result is a molecule of XY₃ type, illustrated by the general formula 3. A carbonate group is focal group here.

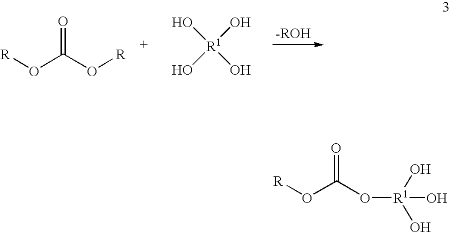

R in the formulae 1-3 has the definition given at the outset, and R¹ is an aliphatic or aromatic radical.

The condensate (K) may, by way of example, also be prepared from a carbonate and a trihydric alcohol, as illustrated by the general formula 4, the molar reaction ratio being 2:1. Here, the average result is a molecule of X₂Y type, an OH group being focal group here. In formula 4, R and R¹ are as defined in formulae 1-3.

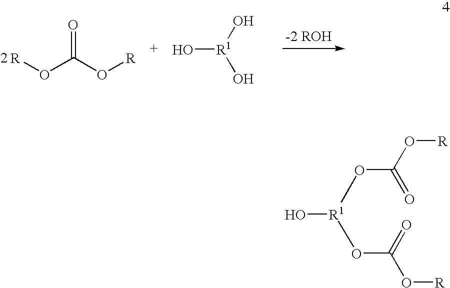

If difunctional compounds, e.g. a dicarbonate or a diol, are also added to the components, this extends the chains, as illustrated by way of example in the general formula 5. The average result is again a molecule of XY₂ type, a carbonate group being focal group.

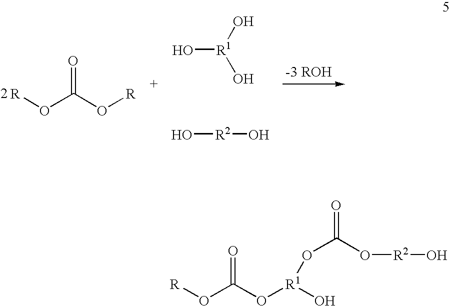

In formula 5, R² is an organic, preferably aliphatic radical, and R and R¹ are as defined above.

It is also possible to use two or more condensates (K) for the synthesis. Firstly, two or more alcohols and, respectively, two or more carbonates may be used here. Furthermore, mixtures of various condensates of different structure can be obtained via the selection of the ratio of the alcohols used and of the carbonates and, respectively, the phosgenes. This will be illustrated taking the example of the reaction of a carbonate with a trihydric alcohol. If the starting materials are used in a ratio of 1:1, as illustrated in (II), the product is an XY₂ molecule. If the starting materials are used in a ratio of 2:1, as illustrated in (IV), the product is an X₂Y molecule. If the ratio is between 1:1 and 2:1 the product is a mixture of XY₂ and X₂Y molecules.

According to the invention, the simple condensates (K) described by way of example in the formulae 1-5 preferentially react intermolecularly to form high-functionality polycondensates, hereinafter termed polycondensates (P). The reaction to give the condensate (K) and to give the polycondensate (P) usually takes place at a temperature of from 0 to 250° C., preferably from 60 to 160° C., in bulk or in solution. Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one preferred embodiment, the condensation reaction is carried out in bulk. The phenol or the monohydric alcohol ROH liberated during the reaction can be removed by distillation from the reaction equilibrium to accelerate the reaction, if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, or potassium, or of cesium, tertiary amines, guanidines, ammonium compounds, phosphonium compounds, organoaluminum, organotin, organozinc, organotitanium, organozirconium, or organobismuth compounds, or else what are known as double metal cyanide (DMC) catalysts, e.g. as described in DE 10138216 or DE 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (P) may moreover be adjusted by way of the composition of the starting components and by way of the residence time.

The condensates (K) and/or the polycondensates (P) prepared at an elevated temperature are usually stable at room temperature for a relatively long period.

The nature of the condensates (K) permits polycondensates (P) with different structures to result from the condensation reaction, these having branching but no crosslinking. Furthermore, in the ideal case, the polycondensates (P) have either one carbonate group as focal group and more than two OH groups or else one OH group as focal group and more than two carbonate groups. The number of the reactive groups here is the result of the nature of the condensates (K) used and the degree of polycondensation.

By way of example, a condensate (K) according to the general formula 2 can react via triple intermolecular condensation to give two different polycondensates (P), represented in the general formulae 6 and 7.

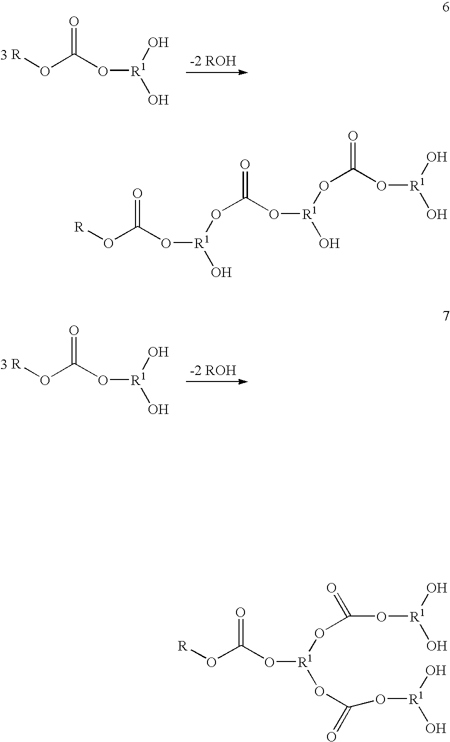

In formula 6 and 7, R and R¹ are as defined above.

There are various ways of terminating the intermolecular polycondensation reaction. By way of example, the temperature may be lowered to a range where the reaction stops and the product (K) or the polycondensate (P) is storage-stable.

It is also possible to deactivate the catalyst, for example in the case of basic catalysts via addition of Lewis acids or protonic acids.

In another embodiment, as soon as the intermolecular reaction of the condensate (K) has produced a polycondensate (P) with the desired degree of polycondensation, a product having groups reactive toward the focal group of (P) may be added to the product (P) to terminate the reaction. For example, in the case of a carbonate group as focal group, by way of example, a mono-, di-, or polyamine may be added. In the case of a hydroxy group as focal group, by way of example, a mono-, di-, or polyisocyanate, a compound comprising epoxy groups, or an acid derivative which reacts with OH groups, can be added to the product (P).

The inventive high-functionality polycarbonates are mostly prepared in the pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the product is stripped, i.e. freed from low-molecular-weight, volatile compounds. For this, once the desired degree of conversion has been achieved the catalyst can optionally be deactivated and the low-molecular-weight volatile constituents, e.g. monoalcohols, phenols, carbonates, hydrogen chloride, or high-volatility oligomerics or cyclic compounds can be removed by distillation, if appropriate with introduction of a gas, preferably nitrogen, carbon dioxide, or air, if appropriate at reduced pressure.

In another preferred embodiment, the inventive polycarbonates can obtain other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulfonic acids, derivatives of phosphonic acids, silane groups, siloxane groups, aryl radicals, or long-chain alkyl radicals, besides hydroxy groups, carbonate groups or carbamoyl groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)-aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethylethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups or having urea groups.

Addition of dicarboxylic acids or tricarboxylic acids, or, for example, dimethyl terephthalate, or tricarboxylic esters can produce ester groups.

Subsequent functionalization can be achieved by using an additional step of the process (step c)) to react the resultant high-functionality highly branched, or high-functionality hyperbranched polycarbonate with a suitable functionalizing reagent which can react with the OH and/or carbonate groups or carbamoyl groups of the polycarbonate.

By way of example, high-functionality highly branched, or high-functionality hyper-branched polycarbonates comprising hydroxy groups can be modified via addition of molecules comprising acid groups or comprising isocyanate groups. By way of example, polycarbonates comprising acid groups can be obtained via reaction with compounds comprising anhydride groups.

High-functionality polycarbonates comprising hydroxy groups may moreover also be converted into high-functionality polycarbonate polyether polyols via reaction with alkylene oxides, e.g. ethylene oxide, propylene oxide, or butylene oxide.

A great advantage of the process is its cost-effectiveness. Both the reaction to give a condensate (K) or polycondensate (P) and also the reaction of (K) or (P) to give polycarbonates with other functional groups or elements can take place in one reactor, this being advantageous technically and in terms of cost-effectiveness.

The inventive molding compositions may comprise, as component B2) at least one hyperbranched polyester of AₓB_{y} type, where

x is at least 1.1, preferably at least 1.3, in particular at least 2

y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B2) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B2) preferably has an Mₙ of from 300 to 30 000 g/mol, in particular from 400 to 25 000 g/mol, and very particularly from 500 to 20 000 g/mol, determined by means of GPC, PMMA standard, dimethylacetamide eluent.

B2) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The T_{g} is preferably from −50° C. to 140° C., and in particular from −50° C. to 100° C. (by means of DSC, to DIN 53765).

Preference is particularly given to those components B2) in which at least one OH or COOH number is greater than 0, preferably greater than 0.1, and in particular greater than 0.5.

The inventive component B2) is in particular obtainable via the processes described below, inter alia by reacting
(a) one or more dicarboxylic acids or one or more derivatives of the same with one or more at least trihydric alcohols or
(b) one or more tricarboxylic acids or higher polycarboxylic acids or one or more derivatives of the same with one or more diols
   in the presence of a solvent and optionally in the presence of an inorganic, organometallic, or low-molecular-weight organic catalyst, or of an enzyme. The reaction in solvent is the preferred preparation method.

For the purposes of the present invention, high-functionality hyperbranched polyesters B2) have molecular and structural non-uniformity. Their molecular non-uniformity distinguishes them from dendrimers, and they can therefore be prepared at considerably lower cost.

Among the dicarboxylic acids which can be reacted according to variant (a) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω)-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and transcyclopentane-1,3-dicarboxylic acid,

and the abovementioned dicarboxylic acids may have substitution by one or more radicals selected from

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl;

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned of representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (a) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are Preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

In the preferred preparation process it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl ester thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are Preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain component B2).

Examples of diols used for variant (b) of the present invention are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds from the above compounds, where n is a whole number and n=4 to 25. One, or else both, hydroxy groups here in the abovementioned diols may also be substituted by SH groups.

Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may either derive from chemical causes (e.g. primary/secondary/tertiary OH group) or from steric causes.

By way of example, the triol may comprise a triol which has primary and secondary hydroxy groups, preferred example being glycerol.

When the inventive reaction is carried out according to variant (a), it is preferable to operate in the absence of diols and monohydric alcohols.

When the inventive reaction is carried out according to variant (b), it is preferable to operate in the absence of mono- or dicarboxylic acids.

The inventive process is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethyl-benzene, chlorobenzene and ortho- and meta-dichlorobenzene. Other very particularly suitable solvents in the absence of acidic catalysts are: ethers, such as dioxane or tetrahydrofuran, and ketones, such as methyl ethyl ketone and methyl isobutyl ketone.

According to the invention, the amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate reduces markedly at markedly lower concentrations of the reactants, giving uneconomically long reaction times.

To carry out the process preferred according to the invention, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. Distillation may also be used to remove alcohol or water formed during the reaction, and, by way of example, a water separator may be used.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

For the purposes of the present invention, examples of acidic inorganic catalysts are sulfuric acid, phosphoric acid, phosphonic acid, hypophosphorous acid, aluminum sulfate hydrate, alum, acidic silica gel (pH=6, in particular=5), and acidic aluminum oxide. Examples of other compounds which can be used as acidic inorganic catalysts are aluminum compounds of the general formula Al(OR)₃ and titanates of the general formula Ti(OR)₄, where each of the radicals R may be identical or different and is selected independently of the others from

C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. Acidic ion exchangers may also be used as acidic organic catalysts, e.g. polystyrene resins comprising sulfonic acid groups and crosslinked with about 2 mol % of divinylbenzene.

It is also possible to use combinations of two or more of the abovementioned catalysts. It is also possible to use an immobilized form of those organic or organometallic, or else inorganic, catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The inventive process is carried out under inert gas, e.g. under carbon dioxide, nitrogen, or a noble gas, among which mention may particularly be made of argon.

The inventive process is carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred.

The pressure conditions for the inventive process are not critical per se. It is possible to operate at markedly reduced pressure, e.g. at from 10 to 500 mbar. The inventive process may also be carried out at pressures above 500 mbar. A reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred.

The reaction time for the inventive process is usually from 10 minutes to 25 hours, preferably from 30 minutes to 10 hours, and particularly preferably from one to 8 hours.

Once the reaction has ended, the high-functionality hyperbranched polyesters can easily be isolated, e.g. by removing the catalyst by filtration and concentrating the mixture, the concentration process here usually being carried out at reduced pressure. Other work-up methods with good suitability are precipitation after addition of water, followed by washing and drying.

Component B2) can also be prepared in the presence of enzymes or decomposition products of enzymes (according to DE-A 101 63163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geolrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterases from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known per se, e.g. from Kurt Faber, “Biotransformations in organic chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme used is from 0.1 to 20% by weight, in particular from 10 to 15% by weight, based on the total weight of the starting materials used and to be reacted.

The inventive process is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The inventive process is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The inventive process is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. Reaction at atmospheric pressure is preferred.

The reaction time for the inventive process is usually from 4 hours to 6 days, preferably from 5 hours to 5 days, and particularly preferably from 8 hours to 4 days.

Once the reaction has ended, the high-functionality hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The high-functionality, hyperbranched polyesters obtainable by the inventive process feature particularly low contents of discolored and resinified material. For the definition of hyperbranched polymers, see also: P. J. Flory, J. Am. Chem. Soc. 1952, 74, 2718, and A. Sunder et al., Chem. Eur. J. 2000, 6, no. 1, 1-8. However, in the context of the present invention, “high-functionality hyperbranched” means that the degree of branching, i.e. the average number of dendritic linkages plus the average number of end groups per molecule is from 10 to 99.9%, preferably from 20 to 99%, particularly preferably from 30 to 90% (see in this connection H. Frey et al. Acta Polym. 1997, 48, 30).

The inventive polyesters have a molar mass M_{w} of from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the inventive polyesters in tetrahydrofuran (THF), n-butyl acetate, ethanol, and numerous other solvents, with no gel particles detectable by the naked eye.

The inventive high-functionality hyperbranched polyesters are carboxy-terminated, carboxy- and hydroxy-terminated, and preferably hydroxy-terminated.

The ratios of the components B1): B2) are preferably from 1:20 to 20:1, in particular from 1:15 to 15:1, and very particularly from 1:5 to 5:1 when used in a mixture.

The inventive molding compositions may comprise, as component C), from 0 to 80% by weight, preferably from 0 to 50% by weight, and in particular from 0 to 40% by weight, of other additives.

The inventive molding compositions may comprise, as component C), from 0.01 to 2% by weight, preferably from 0.02 to 0.8% by weight, and in particular from 0.03 to 0.4% by weight of talc, which is a hydrated magnesium silicate of constitution Mg₃[(OH)₂/Si₄O₁₀] or 3 MgO.4 SiO₂ H₂O. These materials are known as three-la phyllosilicates and have triclinic, monoclinic, or rhombic crystalline form, with lamellar habit. Other trace elements which may be present are Mn, Ti, Cr, Ni, Na, and K, and some of the OH groups may have been replaced by fluoride.

It is particularly preferable to use talc whose particle sizes are 100%<20 μm. The particle size distribution is usually determined via sedimentation analysis to DIN 6616-1, and is preferably:

| | |
|---|---|
| <20 μm | 100% by weight |
| <10 μm | 99% by weight |
| <5 μm | 85% by weight |
| <3 μm | 60% by weight |
| <2 μm | 43% by weight |

These products are commercially available as Micro-Talc I.T. extra (Norwegian Talc Minerals).

Suitable sterically hindered phenols C) are in principle any of the compounds which have a phenolic structure and whose phenolic ring has at least one bulky group.

Examples of preferred compounds are those of the formula

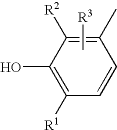

Where:

R¹ and R² are an alkyl group, a substituted alkyl group, or a substituted triazole group, and the radicals R¹ and R² here may be identical or different, and R³ is an alkyl group, a substituted alkyl group, an alkoxy group, or a substituted amino group.

Antioxidants of the type mentioned are described, for example, in DE-A 27 02 661 (U.S. Pat. No. A 4 360 617).

Another group of preferred sterically hindered phenols derives from substituted benzenecarboxylic acids, in particular from substituted benzenepropionic acids.

Particularly preferred compounds of this class have the formula 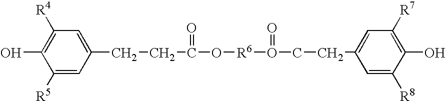
where R⁴, R⁵, R⁷ and R⁸, independently of one another, are C₁-C₈-alkyl which may in turn have substitution (at least one of these is a bulky group) and R⁶ is a bivalent aliphatic radical which has from 1 to 10 carbon atoms and may also have C—O bonds in its main chain.

Preferred compounds of this formula are

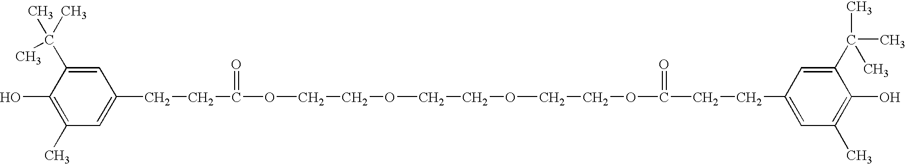

(Irganox® 245 from Ciba-Geigy)

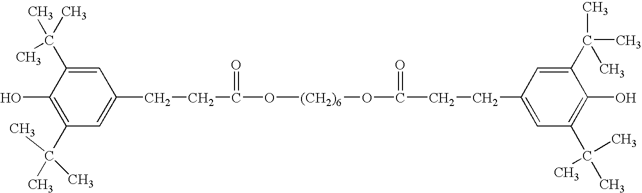

(Irganox® 259 from Ciba-Geigy)

Examples of sterically hindered phenols which should be mentioned are:

2,2′-methylenebis(4-methyl-6-tert-butylphenol), 1,6-hexanediol bis[3-(3,5-di-tert-butyl-4-hydroxyphenyl)propionate], pentaerythritol tetrakis[3-(3,5-di-tert-butyl-4-hydroxyphenyl)-propionate], distearyl 3,5-di-tert-butyl-4-hydroxybenzyl-phosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine and N,N′-hexamethylenebis-3,5-di-tert-butyl-4-hydroxyhydrocinnamide.

Compounds which have proven especially effective and which are therefore preferably used are 2,2′-methylenebis(4-methyl-6-tert-butylphenol), 1,6-hexanediol bis(3,5-di-tert-butyl-4-hydroxy-phenyl]propionate (Irganox® 259), pentaerythrityl tetrakis-[3-(3,5-di-tert-butyl-4-hydroxyphenyl)propionate] and the Irganoxe 245 described above from Ciba Geigy, which is particularly suitable.

The amounts which may be used of the antioxidants (C), which may be used individually or in the form of mixtures, may be from 0.005 to 2% by weight, preferably from 0.1 to 1.0% by weight, based on the total weight of the molding compositions A) to C).

Sterically hindered phenols which have proven particularly advantageous in some cases, in particular when assessing color stability on storage in diffuse light over prolonged periods, have no more than one sterically hindered group in the ortho position to the phenolic hydroxyl group.

The polyamides which can be used as components C) are known per se. Use may be made of partly crystalline or amorphous resins as described, for example, in the Encyclopedia of Polymer Science and Engineering, Vol. 11, John Wiley & Sons, Inc., 1988, pp. 315-489. The melting point of the polyamide here is preferably below 225° C., and particularly preferably below 21 5° C.

Examples of these are polyhexamethylene azelamide, polyhexamethylene sebacamide, polyhexamethylene dodecanediamide, poly-11-aminoundecanamide and bis(p-aminocyclohexyl)methyidodecanediamide, and the products obtained by ring-opening of lactams, for example polylaurolactam. Other suitable polyamides are based on terephthalic or isophthalic acid as acid component and/or trimethylhexamethyl-enediamine or bis(p-aminocyclohexyl)propane as diamine component and polyamide base resins prepared by copolymerizing two or more of the abovementioned polymers or components thereof.

Particularly suitable polyamides which may be mentioned are copolyamides based on caprolactam, hexamethylenediamine, p,p′-diaminodicyclohexylmethane and adipic acid. An example of these is the product marketed by BASF Aktiengesellschaft with the name Ultramid® 1 C.

Other suitable polyamides are marketed by Du Pont with the name Elvamide®.

The preparation of these polyamides is also described in the abovementioned text. The ratio of terminal amino groups to terminal acid groups can be controlled by varying the molar ratio of the starting compounds.

The proportion of the polyamide in the molding composition of the invention is from 0.001 to 2% by weight, by preference from 0.005 to 1.99% by weight, preferably from 0.01 to 0.08% by weight.

The dispersibility of the polyamides used can be improved in some cases by concomitant use of a polycondensation product made from 2,2-di(4-hydroxyphenyl)propane (bisphenol A) and epichlorohydrin.

Condensates of this type made from epichlorohydrin and bisphenol A are commercially available. Processes for their preparation are also known to the person skilled in the art. Tradenames of the polycondensates are Phenoxy® (Union Carbide Corporation) and Epikote® (Shell). The molecular weight of the polycondensates can vary within wide limits. In principle, any of the commercially available grades is suitable.

The inventive polyoxymethylene molding compositions may comprise, as component C), from 0.002 to 2.0% by weight, preferably from 0.005 to 0.5% by weight, and in particular from 0.01 to 0.3% by weight, based on the total weight of the molding compositions, of one or more of the alkaline earth metal silicates and/or alkaline earth metal glycerophosphates. Alkaline earth metals which have proven preferable for forming the silicates and glycerophosphates are calcium and, in particular, magnesium. Useful compounds are calcium glycerophosphate and preferably magnesium glycerophosphate and/or calcium silicate and preferably magnesium silicate. Particularly preferable alkaline earth metal silicates here are those described by the formula
Me. x SiO₂.n H₂O

where

Me is an alkaline earth metal, preferably calcium or in particular magnesium,

x is a number from 1.4 to 10, preferably from 1.4 to 6, and

n is a number greater than or equal to 0, preferably from 0 to 8.

The compounds C) are advantageously used in finely ground form. Particularly suitable products have an average particle size of less than 100 μm, preferably less than 50 μm.

Preference is given to the use of calcium silicates and magnesium silicates and/or calcium glycerophosphates and magnesium glycerophosphates. Examples of these may be defined more precisely by the following properties:

Calcium silicate and magnesium silicate, respectively:

content of CaO and MgO, respectively: from 4 to 32% by weight, preferably from 8 to 30% by weight and in particular from 12 to 25% by weight,

ratio of SiO₂ to CaO and SiO₂ to MgO, respectively (mol/mol): from 1.4 to 10, preferably from 1.4 to 6 and in particular from 1.5 to 4,

bulk density: from 10 to 80 g/l 00 ml, preferably from 10 to 40 g/l 00 ml, and average

particle size: less than 100μm, preferably less than 50 μm and

Calcium glycerophosphates and magnesium glycerophosphates, respectively:

content of CaO and MgO, respectively: above 70% by weight, preferably above 80% by weight

residue on ignition: from 45 to 65% by weight

melting point: above 300° C. and

average particle size: less than 100 μm, preferably less than 50 μm.

The inventive molding compositions may comprise, as component C), from 0.01 to 5% by weight, preferably from 0.09 to 2% by weight, and in particular from 0.1 to 0.7% by weight, of at least one ester or amide of saturated or unsaturated aliphatic carboxylic acids having from 10 to 40 carbon atoms, preferably from 16 to 22 carbon atoms, with polyols or with saturated aliphatic alcohols or amines having from 2 to 40 carbon atoms, preferably from 2 to 6 carbon atoms, or with an ether derived from alcohols and ethylene oxide.

The carboxylic acids may be mono- or dibasic. Examples which may be mentioned are pelargonic acid, palmitic acid, lauric acid, margaric acid, dodecanedioic acid, behenic acid and, particularly preferably, stearic acid, capric acid and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol and pentaerythritol, and preference is given to glycerol and pentaerythritol.

The aliphatic amines may be mono- to tribasic. Examples of these are stearylamine, ethylenediamine, propylenediamine, hexamethylenediamine and di(6-aminohexyl)amine, and particular preference is given to ethylenediamine and hexamethylenediamine. Correspondingly, preferred esters and amides are glycerol distearate, glycerol tristearate, ethylenediamine distearate, glycerol monopalmitate, glycerol trilaurate, glycerol monobehenate and pentaerythritol tetrastearate.

It is also possible to use mixtures of different esters or amides or esters with amides combined, in any desired mixing ratio.

Other suitable compounds are polyether polyols and polyester polyols which have been esterified with mono- or polybasic carboxylic acids, preferably fatty acids, or have been etherified. Suitable products are available commercially, for example Loxiol® EP 728 from Henkel KGaA.

Preferred ethers derived from alcohols and ethylene oxide have the general formula
RO (CH₂ CH₂ O)ₙ H
where R is an alkyl group having from 6 to 40 carbon atoms and n is an integer greater than or equal to 1.

R is particularly preferably a saturated C₁₆-C₁₈ fatty alcohol where n is 50, this alcohol being obtainable commercially from BASF as Lutensole AT 50.

The inventive molding compositions may comprise, as other components C), from 0.0001 to 1% by weight, preferably from 0.001 to 0,8% by weight, and in particular from 0.01 to 0.3% by weight, of other nucleating agents.

Any of the known nucleating agents may be used, examples being melamine cyanurate, boron compounds, such as boron nitride, silica, pigments, e.g. Heliogen Blue® (copper phthalocyanine pigment; registered trademark of BASF Aktiengesellschaft).

Examples of fillers which may be mentioned are amounts of up to 50% by weight, preferably from 5 to 40% by weight, of potassium titanate whiskers, carbon fibers, and preferably glass fibers, and these glass fibers may take the form of glass fabrics, glass mats, glass nonwovens, and/or glass silk rovings, for example, or of cut glass silk composed of low-alkali E glass with diameter of from 5 to 200 μm, preferably from 8 to 50 μm, the average length of the fibrous fillers after their incorporation preferably being from 0.05 to 1 mm, in particular from 0.1 to 0.5 mm.

Examples of other suitable fillers are calcium carbonate or glass beads, preferably in ground form, or a mixture of these fillers.

Other additives which may be mentioned are amounts of up to 50% by weight, preferably from 0 to 40% by weight, of impact-modifying polymers (also termed elastomeric polymers or elastomers below).

Preferred types of these elastomers are those known as ethylene-propylene rubbers (EPM) or ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes cyclooctadienes and dicyclopentadiene, and also alkenyinorbornenes, such as 5-ethylidene-2-norbornene, 5-butylidene-2-norbrnene, 2-methallyl-5-norbornene and 2-isopropenyl-5-norbornene, and tricyclodienes, such as 3-methyltricyclo[5.2.1.02.6]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

The EPDM rubbers may also have been grafted with other monomers, e.g. with glycidyl (meth)acrylates, (meth)acrylates and (meth)acrylamides.

Copolymers of ethylene with esters of methacrylic acid are another group of preferred rubbers. The rubbers may also comprise monomers comprising epoxy groups. These monomers comprising epoxy groups are preferably incorporated into the rubber by adding to the monomer mixture monomers comprising epoxy groups and having the general formulae I or II 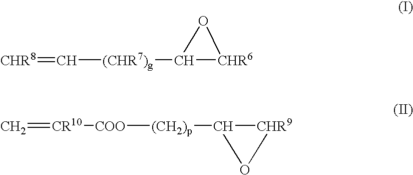
where R⁶ to R¹⁰ are hydrogen or alkyl groups having from 1 to 6 carbon atoms, and m is a whole number from 0 to 20, g is a whole number from 0 to 10 and p is a whole number from 0 to 5.

R⁶ to R⁸ are preferably hydrogen, where m is 0 or 1 and g is 1. The corresponding compounds are allyl glycidyl ether and vinyl glycidyl ether.

Preferred compounds of the formula II are esters of acrylic acid and/or methacrylic acid, where these esters comprise epoxy groups, examples being glycidyl acrylate and glycidyl methacrylate.

The copolymers are advantageously composed of from 50 to 98% by weight of ethylene, and from 0 to 20% by weight of monomers comprising epoxy groups, the remaining amount being (meth)acrylates.

Particular preference is given to copolymers composed of

from 50 to 98% by weight, in particular from 55 to 95% by weight, of ethylene,

from 0.1 to 40% by weight, in particular from 0.3 to 20% by weight, of glycidyl acrylate and/or glycidyl methacrylate, (meth)acrylic acid and/or maleic anhydride, and

from 1 to 50% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion polymerization”. The emulsifiers and catalysts which can be used are known per se.

In principle it is possible to use homogeneously structured elastomers or else those with a shell structure. The shell-type structure is determined, inter alia, by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at the surface. Examples of groups of this type are epoxy, amino and amide groups, and also functional groups which may be introduced by concomitant use of monomers of the general formula 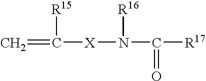
where the substituents are defined as follows:
R¹⁵ is hydrogen or a C₁-C₄-alkyl group,
R¹⁶ is hydrogen, a C₁-C₈-alkyl group or an aryl group, in particular phenyl,
R¹⁷ is hydrogen, a C₁-C₁₀-alkyl group, a C₆-C₁₂-aryl group or —OR¹⁸
R¹⁸ is a C₁-C₈-alkyl group or C₆-C₁₂-aryl group, if desired with substitution by O— or N— containing groups,
X is a chemical bond, a C₁-C₁₀-alkylene group or C₆-C₁₂-arylene group, or 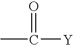
Y is OZ or NH-Z, and
Z is a C₁-C₁₀-alkylene group or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate butanediol diacrylate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of those compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a variety of other suitable graft-linking monomers. For further details reference may be made here, for example, to U.S. Pat. No. 4,148,846.

The proportion of these crosslinking monomers in component C) is generally up to 5% by weight, preferably not more than 3% by weight, based on C).

Some preferred emulsion polymers will be listed below. Mention may first be made here of graft polymers having a core and at least one outer shell, and having the following structure:

| Monomers for core | Monomers for envelope |
|---|---|
| 1,3-butadiene, isoprene, n-butyl | styrene, acrylonitrile, |
| acrylate, ethylhexyl acrylate, or the | (meth)acrylates, if appropriate |
| mixture of these, if appropriate | having reactive groups as |
| together with crosslinking monomers | described herein |

Instead of the graft polymers with a multishell structure, it is also possible to use homogeneous, i.e. single-shell elastomers composed of 1,3-butadiene, isoprene, and n-butyl acrylate, or of copolymers of these. These products, too, may be prepared via concomitant use of crosslinking monomers or of monomers having reactive groups.

The elastomers C) described may also be prepared by other conventional processes, e.g. via suspension polymerization.

Other suitable elastomers which may be mentioned are thermoplastic polyurethanes, described by way of example in EP-A 115 846, EP-A 115 847, and EP-A 117 664.

It is also possible, of course, to use a mixture of the types of rubber listed above.

The inventive molding compositions may also comprise other conventional additives and processing aids. Merely by way of example, mention may be made here of additives for scavenging formaldehyde (formaldehyde scavengers), plasticizers, coupling agents, and pigments. The proportion of these additives is generally in the range from 0.001 to 5% by weight.

The inventive thermoplastic molding compositions are prepared via mixing of the components in a manner known per se, and detailed information would therefore be superfluous here. The components are preferably mixed in an extruder.

In one preferred preparation method, component B) and, if appropriate, component(s) C) may be applied, preferably at room temperature, to pellets of A) and then extruded.

The molding compositions can be used to produce moldings of any type (including semifinished products, foils, films, or foams). The molding compositions feature very low residual formaldehyde content together with good mechanical properties and thermal stability.

In particular, the individual components can be processed in short cycle times and without difficulty (without clumping or caking), therefore in particular permitting application as thin-walled components.

An improved-flow POM can conceivably be used in almost any injection-molding application. The improved flow permits a lower melt temperature and can therefore lead to a marked reduction in the overall cycle time in the injection-molding process (lowering the production costs for an injection molding!). Furthermore, the injection pressures needed during processing are lower, and therefore the total locking force needed on the injection mold becomes lower (less capital expenditure on the injection-molding machine).

The reduction of melt temperature, injection pressures, and cycle time permits particularly non-aggressive processing of the material, with minimal thermo-oxidative degradation. The products thus produced therefore have particularly low emission levels and have almost no detectable odor. At the same time, operating times for molds increase, because there is a particularly low level of release of deposit-forming degradation products.

In overmolding of (for example, metallic) inserts, the reduction in injection pressures reduces the displacement of the insert and therefore improves dimensional stability and service properties and reduces manufacturing waste.

Alongside the improvements in the injection-molding process, the lowering of melt viscosity can give marked advantages in the actual shape of the component. For example, injection molding can be used to produce thin-walled applications which, for example, could not be produced hitherto with filled grades of POM. Similarly, use of POM grades that are reinforced but are more free-flowing could reduce wall thicknesses and therefore reduce component weights in existing applications.

These materials are suitable for production of fibers, or of monofils, or of foils, or of moldings of any type, in particular for applications of the following type:

clips and fasteners

curtain rails and curtain runners

spring elements in food packaging and toys

brush attachments for electric toothbrushes

valve bodies and valve housings for WC flush systems

faucets and functional parts of faucets, e.g. single-lever mixers

shower heads and solvent-conveying internal components

nozzles, bearings, and control elements for irrigation and sprinkler systems and head-lamp wash systems

housings for water filters

brew units for coffee machines

aerosol metering valves and functional parts for sprays

audio- and video-cassette levers and deflector rollers

computer and telephone keyboards

door handles, window handles, and window-handle bases

rollers and functional parts for drawer rails

clasps and snap connectors for belts, bags, and textiles

zip fasteners

containers, closure caps, and displacers for deodorant sticks, lipsticks, cosmetics products

bearing elements, guide bushes, and slide bushes for mechanical engineering and for motor vehicle construction,

office machines, surveillance cameras, dishwashers, seats, headrests, sun visors

gearwheels, spindles, worms, and other components for transmission gearboxes, variable speed gearboxes, and shift transmission systems

rails for sliding roofs in motor vehicles

ball sockets for joints in mechanical engineering and in motor vehicle construction

pendulum supports for motor vehicle construction (chassis)

pedal levers

liquids containers, lids and closures for liquids, inter alia in motor vehicle construction tank lids, tank flanges, filters, housings for filters, pipes, reservoir casings, roll-over valves of fuel systems in motor vehicle construction

pushbuttons for safety-belt locks in motor vehicle construction

wind-up mechanisms for safety belts

loudspeaker grilles

layer separators, suction intakes for broken threads and thread guides in spinning and textile machines

cam disks and control rolls for electromechanical selector devices

transport chain links in mechanical engineering and in chemical engineering

gas meters.

In the kitchen and household sector, the improved-flow POM can be used to produce components for kitchen machines, e.g. fryers, smoothing irons, buttons, and also garden-and-leisure applications, e.g. components for irrigation systems or garden machines.

In the medical technology sector, improved-flow POM makes it easier to produce inhaler casings and components of these.

The morphology of selected compounded materials was studied via transmission electron microscopy. Good dispersion of the particles in the blend was observed. Particle sizes of from 20 to 500 nm were observed.

### EXAMPLES

The following components were used:

Component A)

Polyoxymethylene copolymer composed of 96.2% by weight of trioxane and 3.8% by weight of butanediol formal. The product also comprised about 6-8% by weight of unconverted trioxane and 5% by weight of thermally unstable fractions. Once the thermally unstable fractions had been degraded, the copolymer had a melt volume ratio of 7.5 cm³/10 min. (190° C./2.16 kg, to ISO 1133).

Component C1)

Irganox® 245 from Ciba Geigy:

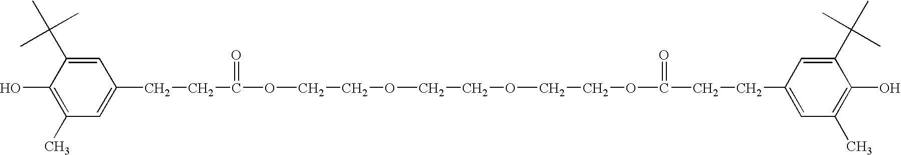

Component C2)

Polyamide oligomer with molar mass of about 3000 g/mol, prepared from caprolactam, hexamethylenediamine, adipic acid and propionic acid (as molecular weight regulator) by analogy with Examples 5-4 of U.S. Pat. No. 3 960 984 (“dicapped PA”).

Component C3)

Synthetic Mg silicate (Ambosol®, Societe Nobel, Puteaux) with the following properties:

| | |
|---|---|
| MgO content | ≧14.8% by weight |
| SiO₂ content | ≧59% by weight |
| SiO₂:MgO ratio | 2.7 mol/mol |
| Bulk density | from 20 to 30 g/100 m |
| Loss in ignition | <25% by weight |

Component C4)

Loxiol® VP 1206 from Henkel KGaA (glycerol distearate)

Component C5)

Melamine-formaldehyde condensate (MFC) as in Example 1 of DE-A 25 40 207.

Examples of Table 1

Preparation specification for polycarbonates B1

General Operating Specification:

One mol of the trihydric alcohols, one mol of diethyl carbonate, and 0.1 g of potassium carbonate were used as initial charge in a three-necked flask, equipped with stirrer, reflux condenser, and internal thermometer, and the mixture was heated to 130° C. and stirred at this temperature for 2 h. As the reaction time increased, the temperature of this reaction mixture reduced as a result of onset of evaporative cooling by the ethanol liberated. The reflux condenser was then replaced by an inclined condenser, ethanol was removed by distillation, and the temperature of the reaction mixture was increased slowly to 180° C.

The reaction products were then analyzed by gel permeation chromatography, the eluent being dimethylacetamide and the standard used being polymethyl methacrylate (PMMA). Glass transition temperature and melting point were determined by means of DSC (Differential Scanning Calorimetry) to ASTM 3418/82, the second heating curve being evaluated.

Component B 1/1

| | | | | | | Visc. | OH |
|---|---|---|---|---|---|---|---|
| | | Conversion | GPC | | | (mPas, | number |
| Polymer class | Constitution | (%) | Mn | Mw | Mw/Mn | 23° C.) | (g/mol) |
| Hyperbranched | (TMP/PO | 70 | 2475 | 7847 | 3.2 | 1260 | 227 |
| polycarbonate | 1:5.4) + DEC | | | | | | |

Component B 1/2

| | | | | | | Visc. | OH |
|---|---|---|---|---|---|---|---|
| | | Conversion | GPC | | | (mPas, | number |
| Polymer class | Constitution | (%) | Mn | Mw | Mw/Mn | 23° C.) | (g/mol) |
| Hyperbranched | (TMP/EO | 70 | 2475 | 7847 | 3.2 | 1260 | 227 |
| polycarbonate | 1:5.4) + DEC | | | | | | |

TMP = trismethylolpropane
DEC = diethyl carbonate
PO = propylene oxide
EO = ethylene oxide

Component B 2/1

1645 g (11.27 mol) of adipic acid and 868 g (9.43 mol) of glycerol were used as initial charge in a 5 I glass flask, equipped with stirrer, internal thermometer, gas inlet tube, reflux condenser, and vacuum connection with cold trap. 2.5 g of di-n-butyltin oxide, commercially available as Fascat® 4201, were added, and the mixture was heated with the aid of an oil bath to an internal temperature of 140° C. A reduced pressure of 250 mbar was applied in order to remove water formed during the reaction. The reaction mixture was kept at the pressure mentioned and the temperature mentioned for 4 h, and then the pressure was reduced to 100 mbar and the mixture was kept at 140° C. for a further 6 h. After 8.5 h, 383 g (4.16 mol) of glycerol were added. The pressure was then lowered to 20 mbar and the mixture was kept at 140° C. for a further 5 h. It was then cooled to room temperature. This gave 2409 g of hyperbranched polyester in the form of a clear, viscous liquid. The analytical data are given below.

| | | | | | COOH | OH |
|---|---|---|---|---|---|---|
| Polymer | Consti- | GPC | | | number | number |
| class | tution | Mn | Mw | Mw/Mn | (g/mol) | (g/mol) |
| Hyper- | Adipic | 2720 | 9890 | 3.64 | 30 | 377 |
| branched | acid + | | | | | |
| polyester | glycerol | | | | | |
| | 60:40 | | | | | |

To prepare the molding compositions, component A was mixed with the amounts given in the table of component B in a dry mixer at a temperature of 23° C. The resultant mixture was homogenized and devolatilized at 230° C. in a vented twin-screw extruder (ZSK 30 from Wernder & Pfleiderer), and the homogenized mixture was extruded in the form of a strand through a die, and pelletized.

The constitutions and the results of the measurements (flow spirals) are found in Table 1.

TABLE 1

| | | | | | | | | | | Stan- |
|---|---|---|---|---|---|---|---|---|---|---|
| Experiment | 1 | 2 | 3 | 4 | 5 | 6 | 7 | 8 | 9 | dard |
| Component | 99 | 98 | 97 | 99 | 98 | 97 | 99 | 98 | 97 | 100 |
| A | | | | | | | | | | |
| Component | 1 | 2 | 3 | | | | | | | |
| B 1/1 | | | | | | | | | | |
| Component | | | | 1 | 2 | 3 | | | | |
| B 1/2 | | | | | | | | | | |
| Component | | | | | | | 1 | 2 | 3 | |
| B 2/1 | | | | | | | | | | |
| Flow spiral | 43 | 43 | 44 | 41 | 41 | 42 | 42 | 42.5 | 42.5 | 39 |
| (mm) | | | | | | | | | | |
| 260° C./80° C. | | | | | | | | | | |

Comp. A (Ultraform® N 2320 003, registered trademark of BASF Aktiengesellschaft) comprised respectively:

0.35 of C1

0.04 of C2

0.05 of C3

0.14 of C4

0.2 of C5

Examples of Table 2

Component A: see component A of Table 1

| | | GPC | | |
|---|---|---|---|---|
| | Constitution | Mn | Mw | Mw/Mn |
| Component | TMP/PO 1:5.4 + DEC | 5700 | 130 000 | 22.8 |
| B 1/1 | | | | |
| Component | TMP/EO 1:3 + DEC | 5000 | 79 000 | 15.8 |
| B 1/2 | | | | |
| Component | TMP + DEC 1:2 | 2300 | 8700 | 3.78 |
| B 1/3 | | | | |

TABLE 2

| | | | | | | | | | | |
|---|---|---|---|---|---|---|---|---|---|---|
| Component A | 100 | 99 | 98 | 96 | 99 | 98 | 96 | 99 | 98 | 96 |
| Component B 1/1 | | | | | 1 | 2 | 4 | | | |
| Component B 1/2 | | | | | | | | 1 | 2 | 4 |
| Component B 1/3 | | 1 | 2 | 4 | | | | | | |
| MVR (190° C., | 7.5 | 10.5 | 10.3 | 11.4 | 10.4 | 10.6 | 11.5 | 10.3 | 10.7 | 10.3 |
| 2.16 kp) | | | | | | | | | | |

Examples of Table 3

Component B 2/2

1.2 mol of cyclohexane-1,2-dicarboxylic anhydride, 0.66 mol of trimethylolpropane, and 0.33 mol of 1,4-cyclohexanedimethanol were used as initial charge in a 1 I glass flask equipped with stirrer, internal thermometer, gas inlet tube, reflux condenser, and vacuum connection with cold trap. 0.4 g of di-n-butyltin oxide was added and the mixture was heated with the aid of an oil bath to an internal temperature of 115° C. A reduced pressure of 110 mbar was applied in order to remove water formed during the reaction. The reaction mixture was kept at the temperature mentioned and the pressure mentioned for 10 hours. Cooling gave the product in the form of a clear solid. The analytical data are given below.

Component B 2/3

1.2 mol of cyclohexane-1,2-dicarboxylic anhydride, 0.33 mol of trimethylolpropane, and 0.66 mol of 1,4-cyclohexanedimethanol were used as initial charge in a 1 I glass flask equipped with stirrer, internal thermometer, gas inlet tube, reflux condenser, and vacuum connection with cold trap. 0.4 g of di-n-butyltin oxide was added and the mixture was heated with the aid of an oil bath to an internal temperature of 115° C. A reduced pressure of 110 mbar was applied in order to remove water formed during the reaction. The reaction mixture was kept at the temperature mentioned and the pressure mentioned for 10 hours. Cooling gave the product in the form of a clear solid. The analytical data are given below.

Component B 2/4

2000 g (12.97 mol) of cyclohexane-1,2-dicarboxylic anhydride (HPA), 380 g (2.83 mol) of trishydroxymethylpropane (TMP), and 817 g (5.67 mol) of cyclohexanedimethanol (CHDM) were used as initial charge in a 4 I jacketed reaction vessel, equipped with stirrer, internal thermometer, gas inlet tube, reflux condenser, and vacuum connection with cold trap. 3.2 g of di-n-butyltin oxide, commercially available as Fascat® 4201, were added, and the mixture was heated with the aid of an oil bath to an internal temperature of from 145 to 150° C. A reduced pressure of 60 mbar was applied in order to remove water formed during the reaction. The reaction mixture was kept at the temperature mentioned and the pressure mentioned for 6.5 hours. 1315 g of TMP were then added, and the reaction was kept at the temperature mentioned and pressure mentioned for a further 16.5 hours until the acid number achieved was 86 mg KOH/g. This gave a hyperbranched polyester in the form of a clear solid.

Component A: see Table 1

Component B 2/1: see Table 1

Component B 2/2

| | | GPC | | | COOH | OH |
|---|---|---|---|---|---|---|
| Polymer | Consti- | | | Mw/ | number | number |
| class | tution | Mn | Mw | Mn | (g/mol) | (g/mol) |
| Hyper- | HPA/TMP/ | 1040 | 1370 | 1.32 | 123 | 150 |
| branched | CHDM | | | | | |
| polyester | 1.2:0.66:0.33 | | | | | |

Component B 2/3

| | | GPC | | | COOH | OH |
|---|---|---|---|---|---|---|
| Polymer | Consti- | | | Mw/ | number | number |
| class | tution | Mn | Mw | Mn | (g/mol) | (g/mol) |
| Hyper- | HPA/TMP/ | 1040 | 1360 | 1.31 | 137 | 78 |
| branched | CHDM | | | | | |
| polyester | 1.2:0.33:0.66 | | | | | |

Component B 2/4

| | | GPC | | | COOH | OH |
|---|---|---|---|---|---|---|
| Polymer | Consti- | | | Mw/ | number | number |
| class | tution | Mn | Mw | Mn | (g/mol) | (g/mol) |
| Hyper- | HPA/TMP/ | 840 | 1310 | 1.55 | 86 | 118 |
| branched | CHDM | | | | | |
| polyester | 1.5:0.66:0.33 | | | | | |

HPA = hydrogenated phthalic anhydride
TMP = trimethylolpropane
CHDM = cyclohexanedimethanol

Analysis of Inventive Products:

The polyesters were analyzed by gel permeation chromatography, using a refractometer as detector. Tetrahydrofuran was used as mobile phase, and polymethyl methacrylate (PMMA) was used as standard for molecular weight determination.

Acid number and OH number were determined to DIN 53240, Part 2.

TABLE 3

| | | | | | | | |
|---|---|---|---|---|---|---|---|
| Component A | 100 | 99 | 98 | 96 | 99 | 98 | 96 |
| Component B 2/1 | | 1 | 2 | 4 | | | |
| Component B 2/2 | | | | | 1 | 2 | 4 |
| MVR (190° C., 2.16 kp) | 7.5 | 11.2 | 10.4 | 10 | 11.4 | 11 | 13.1 |
| Mw | 141 000 | 139 000 | 137 000 | 133 000 | 135 000 | 133 000 | 129 000 |

| | | | | | | |
|---|---|---|---|---|---|---|
| Component A | 100 | 99 | 98 | 96 | 98 | 96 |
| Component B 2/3 | | 1 | 2 | 4 | | |
| Component B 2/4 | | | | | 2 | 4 |
| MVR (190° C., 2.16 kp) | 7.5 | 10.8 | 11.9 | 13.2 | 11 | 12.4 |
| Mw | 141 000 | 135 000 | 133 000 | 132 000 | 135 000 | 131 000 |

1. A thermoplastic molding composition, comprising:
A) from 10 to 98% by weight of at least one polyoxymethylene homo- or copolymer;
B) from 0.01 to 50% by weight of
B1) at least one highly branched or hyperbranched polycarbonate with an OH number of from 1 to 600 mg KOH/g of polycarbonate (DIN 53240, Part 2), or
B2) at least one highly branched or hyperbranched polyester of AₓB_{y} type, where x is at least 1.1 and y is at least 2.1, or a mixture of these; and
C) from 0 to 60% by weight of other additives,
wherein the total of the percentages by weight of components A) to D) is 100%.

2. The thermoplastic molding composition according to claim 1, wherein component B1) has a number-average molar mass Mₙ of from 100 to 15 000 g/mol.

3. The thermoplastic molding composition according to claim 1, wherein component B1) has a glass transition temperature Tg of from −80° C. to 140° C.

4. The thermoplastic molding composition according to claim 1, wherein component B1) has a viscosity (mpas) at 23° C. (DIN 53019) of from 50 to 200 000.

5. The thermoplastic molding composition according to claim 1, wherein component B2) has a number-average molar mass Mₙ of from 300 to 30 000 g/mol.

6. The thermoplastic molding composition according to claim 1, wherein component B2) has a glass transition temperature T_{g} of from −50 to 140° C.

7. The thermoplastic molding composition according to claim 1, wherein component B2) has an OH number (DIN 53240) of from 0 to 600 mg KOH/g of polyester.

8. The thermoplastic molding composition according to claim 1, wherein component B2) has a COOH number (DIN 53240) of from 0 to 600 mg KOH/g of polyester.

9. The thermoplastic molding composition according to claim 1, wherein component B2) has at least one OH number or COOH number greater than 0.

10. The thermoplastic molding composition according to claim 1, wherein the ratio of components B 1): B2) is from 1:20 to 20:1.

11. (canceled)

12. A fiber, a foil, or a molding, obtainable from the thermoplastic molding composition according to claim 1.

13. A method of making a fiber, foil, or molding, the method comprising:
preparing a thermoplastic molding composition according to claim 1; and
forming a fiber, foil, or molding from the thermoplastic molding composition.

14. The thermoplastic molding composition according to claim 2, wherein component B1) has a glass transition temperature Tg of from −80° C. to 140° C.

15. The thermoplastic molding composition according to claim 2, wherein component B1) has a viscosity (mPas) at 23° C. of from 50 to 200 000.

16. The thermoplastic molding composition according to claim 3, wherein component B1) has a viscosity (mPas) at 23° C. of from 50 to 200 000.

17. The thermoplastic molding composition according to claim 2, wherein component B2) has a number-average molar mass Mₙ of from 300 to 30 000 g/mol.

18. The thermoplastic molding composition according to claim 3, wherein component B2) has a number-average molar mass Mₙ of from 300 to 30 000 g/mol.

19. The thermoplastic molding composition according to claim 4, wherein component B2) has a number-average molar mass Mₙ of from 300 to 30 000 g/mol.

20. The thermoplastic molding composition according to claim 2, wherein component B2) has a glass transition temperature T_{g} of from −50 to 140° C.

21. The thermoplastic molding composition according to claim 3, wherein component B2) has a glass transition temperature T_{g} of from −50 to 140° C.
